(19) United States
(12) Patent Application Publication
(10) Pub. No.: US 2026/0342165 A1
(43) Pub. Date: Oct. 29, 2026

(54) STATOR

(71) Applicant: DENSO CORPORATION, Kariya-city (JP)

(72) Inventors: Atsushi OKUSE, Kariya-city (JP); Naoto Natsume, Kariya-city (JP); Masayuki Echizen, Kariya-city (JP)

(73) Assignee: DENSO CORPORATION, Kariya-city (JP)

(21) Appl. No.: 19/712,798

(22) Filed: Jun. 18, 2026

Related U.S. Application Data
(63) Continuation of application No. PCT/JP2024/042554, filed on Dec. 2, 2024.

(30) Foreign Application Priority Data
Feb. 2, 2024 (JP) 2024-015189

(51) Int. Cl. H02K 3/52

(52) U.S. Cl. CPC H02K 3/522; H02K 2203/12

(57) ABSTRACT

A stator includes a stator core having a plurality of tooth portions extending radially, a resin insulator attached to the stator core, and winding portions wound around the plurality of tooth portions via the insulator. The insulator has attachment portions attached to attachment surfaces of the stator core. Grooves opening toward the attachment surface side are formed in the attachment portions. Gas layers are formed between the stator core and the winding portions by the grooves.

### CROSS-REFERENCE OF RELATED APPLICATIONS

This application is the U.S. bypass application of International Application No. PCT/JP2024/042554 filed on Dec. 2, 2024, which designated the U.S. and claims priority to Japanese Patent Application No. 2024-015189 filed on Feb. 2, 2024, and the contents of both of these are incorporated herein by reference.

### BACKGROUND

### Technical Field

The present disclosure relates to a stator.

### Description of the Related Art

In the field of stators, there is known a stator including a stator core having a plurality of tooth portions extending radially, an insulating film attached to the stator core, and winding portions wound around the plurality of tooth portions via the insulating film. According to this stator, assemblability and insulation reliability can be improved.

### SUMMARY

According to one aspect of the present disclosure, a stator includes a stator core having a plurality of tooth portions extending radially, a resin insulator attached to the stator core, and winding portions wound around the plurality of tooth portions via the insulator. The insulator has attachment portions attached to attachment surfaces of the stator core. Grooves opening toward the attachment surface side are formed in the attachment portions. Gas layers are formed between the stator core and the winding portions by the grooves.

### BRIEF DESCRIPTION OF THE DRAWINGS

The above-described objects and other objects, features and advantages of the present disclosure will be clarified further by the following detailed description with reference to the accompanying drawings. The drawings are:

FIG. 1 is a plan view of a stator according to one embodiment of the present disclosure;

FIG. 2 is a plan view of a stator constituent member;

FIG. 3 is an enlarged view showing a portion A in FIG. 2;

FIG. 4 is a further enlarged view enlarging the portion A in FIG. 2;

FIG. 5 is a perspective view of the stator constituent member;

FIG. 6 is a perspective view of a first insulator;

FIG. 7 is a two-side view of the first insulator;

FIG. 8 is an explanatory view illustrating parasitic capacitance;

FIG. 9 is an enlarged view showing a principal part of a stator constituent member according to a first modification;

FIG. 10 is a longitudinal sectional view of the first insulator according to the first modification;

FIG. 11 is an enlarged view showing a principal part of a stator constituent member according to a second modification;

FIG. 12 is an enlarged view showing a principal part of a stator constituent member according to a third modification;

FIG. 13 is a perspective view of a stator constituent member according to a fourth modification;

FIG. 14 is a perspective view of a stator constituent member according to a fifth modification;

FIG. 15 is a perspective view of the first insulator according to a sixth modification;

FIG. 16 is a plan view of the first insulator according to the sixth modification; and

FIG. 17 is a perspective view of the first insulator according to a seventh modification.

### DETAILED DESCRIPTION OF PREFERRED EMBODIMENTS

In the field of stators, there is known a stator including a stator core having a plurality of tooth portions extending radially, an insulating film attached to the stator core, and winding portions wound around the plurality of tooth portions via the insulating film (e.g., JP-A-2018-198515). According to this stator, assemblability and insulation reliability can be improved.

As a result of intensive studies conducted by the inventors, it has been found that, in the above-described stator, since the distance between the tooth portions and the winding portions is reduced by using the insulating film, parasitic capacitance, which is a capacitive component generated due to a potential difference between the stator core and the winding portions, cannot be reduced.

Hereinafter, one embodiment of the present disclosure will be described with reference to the drawings.

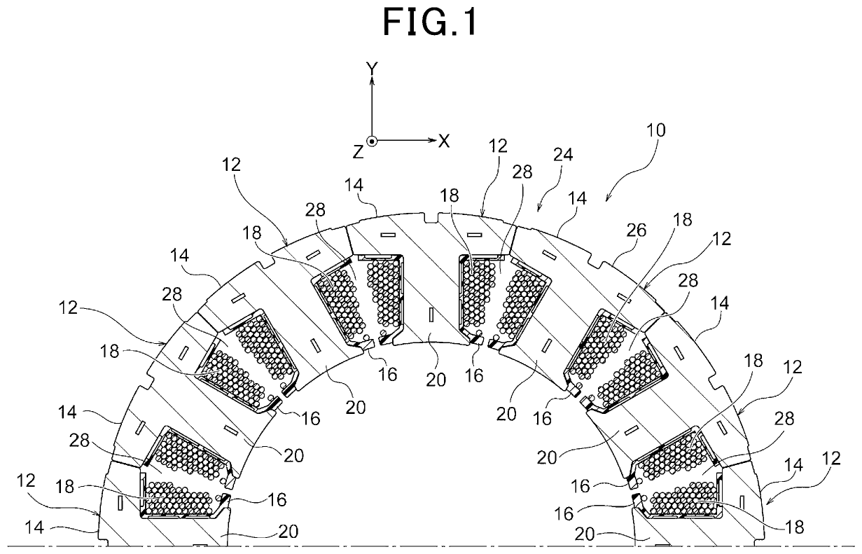

As shown in FIG. 1, a stator 10 according to the present embodiment includes a plurality of stator constituent members 12. The stator 10 is configured by combining the plurality of stator constituent members 12 in an annular shape. FIG. 1 shows a half configuration of the stator 10. The stator 10 is applied to a brushless motor. The brushless motor may be used for any application. Examples of the brushless motor include a fan motor, a pump drive motor, and a compressor motor.

In the drawings, the X direction indicates a tangential direction of the stator 10, the Y direction indicates a radial direction of the stator 10, and the Z direction indicates an axial direction of the stator 10. In the following description, the circumferential direction of the stator 10 refers to a direction around a central axis of the stator 10. A tangential direction, a radial direction, an axial direction, and a circumferential direction of a stator core 24 described later are respectively the same as the tangential direction, the radial direction, the axial direction, and the circumferential direction of the stator 10.

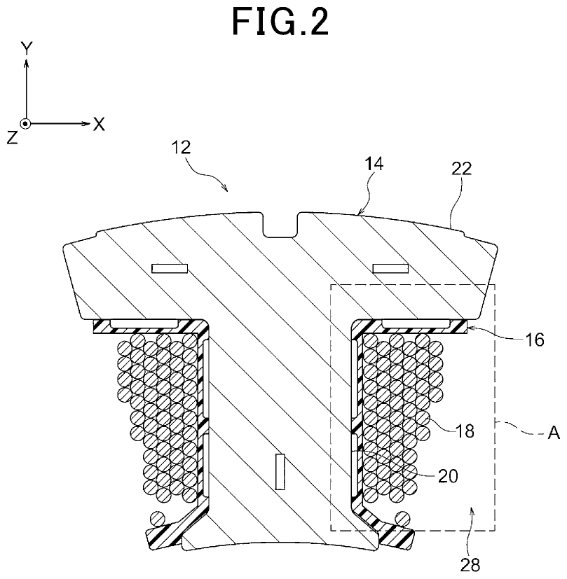

As shown in FIG. 2, each stator constituent member 12 includes a core member 14, an insulator 16, and a winding portion 18. The core member 14 includes a tooth portion 20 and a core back portion 22. The core back portion 22 extends in the circumferential direction of the stator core 24 (see FIG. 1), and the tooth portion 20 extends inward in the Y direction from a central portion of the core back portion 22. A tip end portion of the tooth portion 20 is a free end, and a base end portion of the tooth portion 20 is connected to the core back portion 22.

The stator core 24 (see FIG. 1) is configured by combining the plurality of core members 14 in an annular manner. In a state where the stator core 24 is configured, the plurality of core back portions 22 form an annular portion 26 (see FIG. 1), which is an outer peripheral portion of the stator core 24, and the plurality of tooth portions 20 extend radially about a center portion of the stator core 24. Spaces between the plurality of tooth portions 20 are formed as slots 28.

It should be noted that, although the configuration including details of each stator constituent member 12 is not strictly symmetrical with respect to the X direction when viewed in the Z direction, for convenience of explanation, the principal configuration of each stator constituent member 12 is assumed to be symmetrical with respect to the X direction when viewed in the Z direction, and thus a configuration on one side of each stator constituent member 12 will be described below.

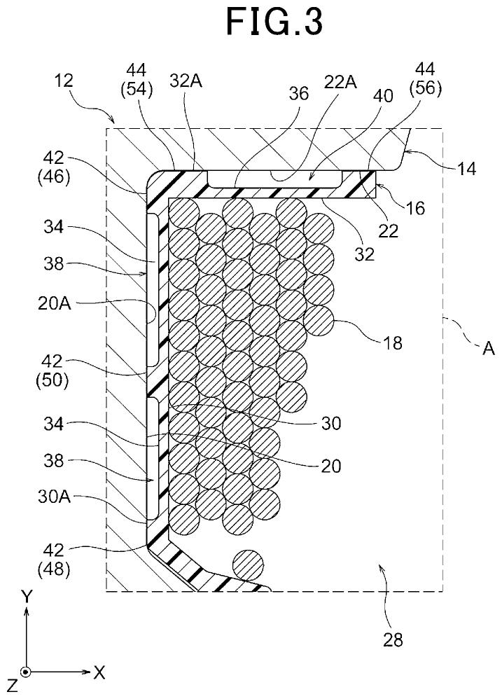

As shown in FIG. 3, the tooth portion 20 is formed with a side surface 20A, and the core back portion 22 is formed with an inner surface 22A. The side surface 20A extends in the Y direction and the Z direction and faces in the X direction. The inner surface 22A extends in the X direction and the Z direction and faces inward in the Y direction. The side surface 20A and the inner surface 22A are in contact with the slot 28.

The insulator 16 is attached to the core member 14. The insulator 16 is made of resin. Examples of the resin forming the insulator 16 include polyimide, polyamide, polyphenylene sulfide (PPS), and polybutylene terephthalate (PBT). The resin forming the insulator 16 may be any resin. The insulator 16 includes a side wall portion 30 and an inner wall portion 32. The side wall portion 30 is attached to the side surface 20A and covers the side surface 20A. The inner wall portion 32 is attached to the inner surface 22A and covers the inner surface 22A. The side wall portion 30 and the inner wall portion 32 are disposed in the slot 28.

The side surface 20A and the inner surface 22A are examples of an ‘attachment surface’ according to the present disclosure. The side wall portion 30 and the inner wall portion 32 are examples of an ‘attachment portion’ according to the present disclosure. The side wall portion 30 is an example of a ‘first attachment portion’ according to the present disclosure, and the inner wall portion 32 is an example of a ‘second attachment portion’ according to the present disclosure.

The winding portion 18 is wound around the tooth portion 20 via the insulator 16. The winding portion 18 is formed by winding a winding wire around the tooth portion 20 about the Y direction. One winding wire forming the winding portion 18 may form only one winding portion 18 by being wound around only one tooth portion 20, or may form a plurality of winding portions 18 by being wound around a plurality of tooth portions 20, respectively.

The side wall portion 30 has an opposing surface 30A opposing the side surface 20A, and the inner wall portion 32 has an opposing surface 32A opposing the inner surface 22A. A first groove 34 is formed in the opposing surface 30A of the side wall portion 30, and a second groove 36 is formed in the opposing surface 32A of the inner wall portion 32. The first groove 34 is open toward the side surface 20A side, and the second groove 36 is open toward the inner surface 22A side. As an example, two first grooves 34 are formed in the opposing surface 30A of the side wall portion 30. The two first grooves 34 are arranged in the Y direction. Further, as an example, one second groove 36 is formed in the opposing surface 32A of the inner wall portion 32.

A first gas layer 38 is formed by the first groove 34 between the tooth portion 20 and the winding portion 18 in the X direction, and a second gas layer 40 is formed by the second groove 36 between the core back portion 22 and the winding portion 18 in the Y direction. That is, the first gas layer 38 is formed inside the first groove 34, and the second gas layer 40 is formed inside the second groove 36. The first groove 34 and the second groove 36 are formed so as to penetrate in the Z direction.

The first groove 34 and the second groove 36 are examples of a ‘groove’ according to the present disclosure. The first gas layer 38 and the second gas layer 40 are examples of a ‘gas layer’ according to the present disclosure.

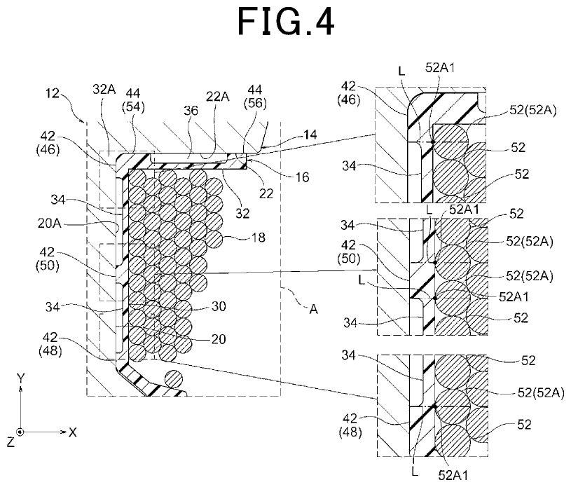

As shown in FIG. 4, the side wall portion 30 has a contact portion 42. The contact portion 42 is formed adjacent to the first groove 34 and is in contact with the side surface 20A. Similarly, the inner wall portion 32 has a contact portion 44. The contact portion 44 is formed adjacent to the second groove 36 and is in contact with the inner surface 22A.

More specifically, the contact portion 42 formed on the side wall portion 30 includes a first contact portion 46 formed at one end portion of the side wall portion 30 in the Y direction, which is the extending direction of the tooth portion 20, a second contact portion 48 formed at the other end portion of the side wall portion 30 in the Y direction, and a third contact portion 50 formed at a central portion of the side wall portion 30 in the Y direction.

Among the winding portions 18, the plurality of first-turn wire portions 52 positioned on the side wall portion 30 side are aligned in the Y direction, which is the extending direction of the tooth portion 20. The plurality of wire portions 52 include an extension-line wire portion 52A located on an extension line L extending, in the normal direction of the side surface 20A of the tooth portion 20, a boundary line between the first groove 34 and the contact portion 42. The plurality of wire portions 52 are aligned such that a top portion 52A1 of the extension-line wire portion 52A on the side wall portion 30 side is positioned on the extension line L. The top portion 52A1 of the extension-line wire portion 52A is a contact point in contact with the side wall portion 30.

More specifically, the contact portion 44 formed on the inner wall portion 32 includes a first contact portion 54 formed at one end portion of the inner wall portion 32 in the X direction and a second contact portion 56 formed at the other end portion of the inner wall portion 32 in the X direction.

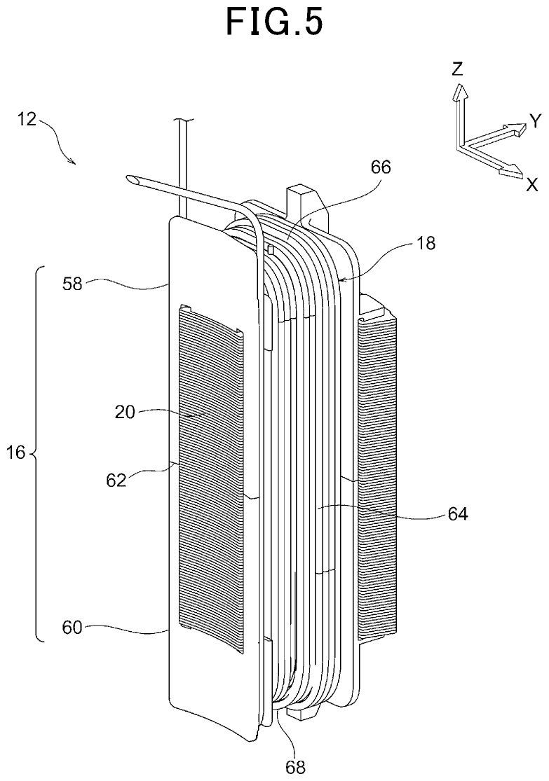

As shown in FIG. 5, the insulator 16 is constituted by a first insulator 58 and a second insulator 60 divided in the Z direction. A dividing portion 62 that divides the first insulator 58 and the second insulator 60 in the Z direction is located, for example, at a central portion of the tooth portion 20 in the Z direction. The first insulator 58 and the second insulator 60 are connected to each other at the dividing portion 62.

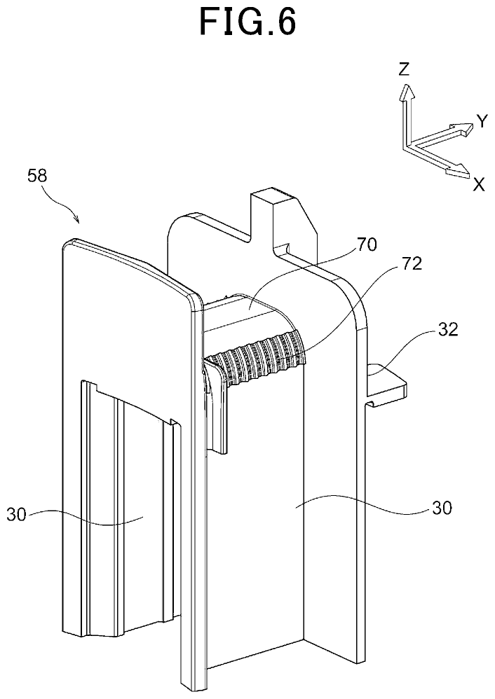

The winding portion 18 includes an axial-direction wiring portion 64 wired in the Z direction along the side wall portion 30 (see FIG. 6) of the tooth portion 20, a coil end portion 66 wired on one side of the tooth portion 20 in the Z direction, and a coil end portion 68 wired on the other side of the tooth portion 20 in the Z direction.

As shown in FIG. 6, the first insulator 58 includes a coil end insulating portion 70. The coil end insulating portion 70 connects one end portions, in the Z direction, of the pair of side wall portions 30. The coil end insulating portion 70 is disposed between the tooth portion 20 and the coil end portion 66 (see FIG. 5) and electrically insulates the tooth portion 20 from the coil end portion 66.

A positioning portion 72 is formed at a connecting portion (corner portion) between the coil end insulating portion 70 and the side wall portion 30. The positioning portion 72 is formed by uneven portions repeatedly arranged in the Y direction. By positioning the plurality of first-turn wire portions 52 (see FIG. 4) of the winding portion 18 by the positioning portion 72, the plurality of wire portions 52 are aligned such that the top portion 52A1 of the extension-line wire portion 52A on the side wall portion 30 side is positioned on the extension line L, as described above.

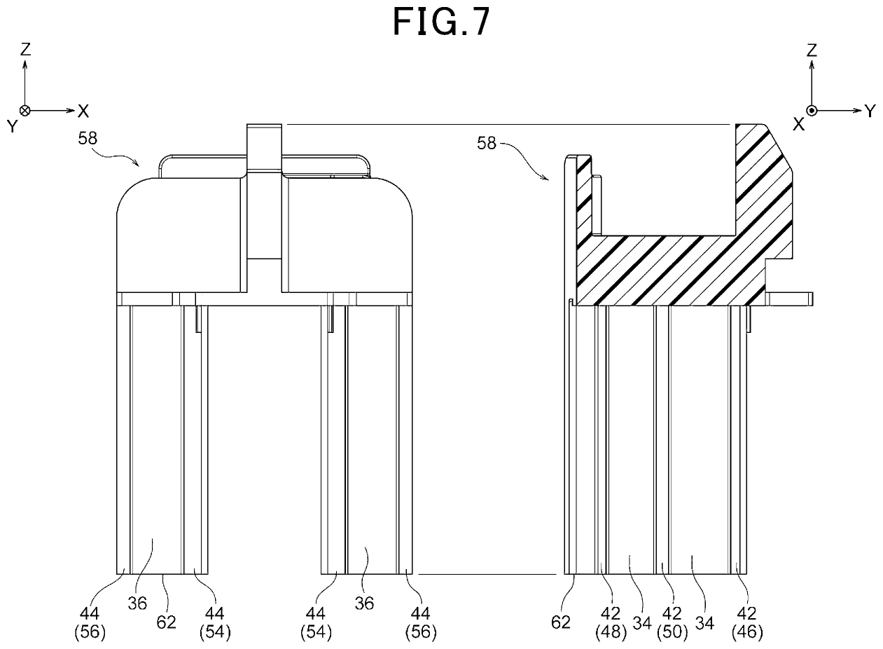

As shown in FIG. 7, the above-described first groove 34, second groove 36, contact portion 42, and contact portion 44 extend in the Z direction and reach the dividing portion 62. The second insulator 60 has a configuration similar to that of the first insulator 58, and thus description thereof will be omitted.

Next, effects and advantages of the present embodiment will be described.

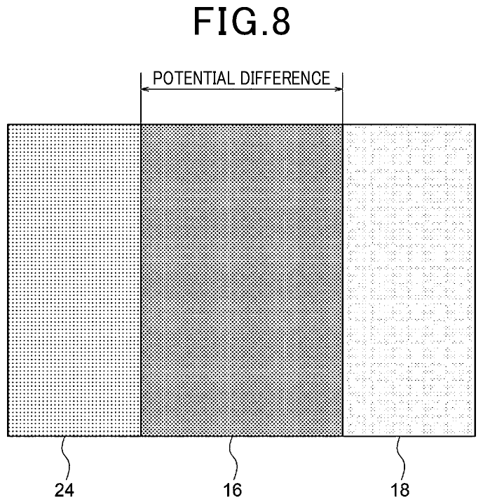

Here, parasitic capacitance will be described with reference to FIG. 8. Parasitic capacitance refers to a capacitive component generated due to a potential difference between the winding portion 18 and the stator core 24. The parasitic capacitance is determined by the following theoretical formula. In the following theoretical formula, the relative permittivity refers to the relative permittivity of the insulator 16, the surface area refers to the surface area of the stator core 24, and the distance refers to the distance between the stator core 24 and the winding portion 18.

Parasitic capacitance ∝relative permittivity×surface area/distance

Due to the parasitic capacitance, noise may be induced by electrostatic induction in an inverter that supplies current to the winding portion 18. As a countermeasure thereto, it may be contemplated to provide the inverter with a noise-cut filter. However, providing the inverter with the noise-cut filter increases cost.

In this regard, in the present embodiment, the first gas layer 38 is formed by the first groove 34 between the tooth portion 20 and the winding portion 18 in the X direction. Accordingly, the relative permittivity can be reduced by the first gas layer 38, whereby the parasitic capacitance between the tooth portion 20 and the winding portion 18 can be reduced. Further, the second gas layer 40 is formed by the second groove 36 between the core back portion 22 and the winding portion 18 in the Y direction. Accordingly, the relative permittivity can be reduced by the second gas layer 40, whereby the parasitic capacitance between the core back portion 22 and the winding portion 18 can be reduced.

Further, by forming the first gas layer 38 and the second gas layer 40 between the winding portion 18 and the stator core 24, the parasitic capacitance between the winding portion 18 and the stator core 24 can be reduced, thereby eliminating the need to provide the inverter with a noise-cut filter. Accordingly, an increase in cost can be suppressed.

Further, since the first gas layer 38 is formed between the tooth portion 20 and the winding portion 18, and the second gas layer 40 is formed between the core back portion 22 and the winding portion 18, the parasitic capacitance between the stator core 24 and the winding portion 18 can be reduced both between the tooth portion 20 and the winding portion 18 and between the core back portion 22 and the winding portion 18, as compared with a case where only one of the first gas layer 38 and the second gas layer 40 is formed.

Further, by forming the first gas layer 38 by the first groove 34 between the tooth portion 20 and the side wall portion 30, the thickness of the side wall portion 30 can be reduced as compared with a case where the tooth portion 20 and the winding portion 18 are insulated only by the side wall portion 30. Similarly, by forming the second gas layer 40 by the second groove 36 between the core back portion 22 and the inner wall portion 32, the thickness of the inner wall portion 32 can be reduced as compared with a case where the core back portion 22 and the winding portion 18 are insulated only by the inner wall portion 32. Accordingly, the cross-sectional area of the slot 28 can be increased, and consequently, the number of turns of the winding portion 18 can be increased, whereby an increase in size of the stator 10 can be suppressed. In other words, an increase in size of the stator 10 for increasing the cross-sectional area of the slot 28 can be suppressed.

Further, the side wall portion 30 has a first contact portion 46 formed at one end portion of the side wall portion 30 and a second contact portion 48 formed at the other end portion of the side wall portion 30, and the first contact portion 46 and the second contact portion 48 are in contact with the side surface 20A of the tooth portion 20. Accordingly, since the side wall portion 30 is supported by the side surface 20A of the tooth portion 20 at the one end portion and the other end portion thereof, rattling of the insulator 16 relative to the stator core 24 can be suppressed.

Further, the side wall portion 30 has a third contact portion 50 formed at a central portion of the side wall portion 30, and the third contact portion 50 is in contact with the side surface 20A of the tooth portion 20. Accordingly, since the side wall portion 30 is supported by the side surface 20A of the tooth portion 20 at the central portion thereof, even when the first groove 34 is formed in the side wall portion 30, bending of the side wall portion 30 toward the side surface 20A due to the tightening force of the winding wire wound around the winding wire winding portion 18 can be suppressed.

Further, the first groove 34 is open toward the side surface 20A side of the tooth portion 20, rather than toward the winding wire winding portion 18 side. Therefore, the winding wire winding portion 18 can be supported by the planar surface on the winding wire winding portion 18 side of the side wall portion 30, whereby deformation of the winding wire winding portion 18 toward the side surface 20A side can be suppressed.

Further, the inner wall portion 32 has a first contact portion 54 formed at one end portion of the inner wall portion 32 and a second contact portion 56 formed at the other end portion of the inner wall portion 32, and the first contact portion 54 and the second contact portion 56 are in contact with the inner surface 22A of the core back portion 22. Accordingly, since the inner wall portion 32 is supported by the inner surface 22A of the core back portion 22 at the one end portion and the other end portion thereof, rattling of the insulator 16 relative to the stator core 24 can be suppressed.

Further, among the plurality of winding portions 52 of the first turn located on the side wall portion 30 side of the winding wire winding portion 18, an extension-line winding portion 52A is provided on an extension line L obtained by extending, in the normal direction of the side surface 20A of the tooth portion 20, a boundary line between the first groove 34 and the contact portion 42, and a top portion 52A1 of the extension-line winding portion 52A on the side wall portion 30 side is located on the extension line L. Therefore, with respect to the top portion 52A1 of the extension-line winding portion 52A, which is located at a short distance from the tooth portion 20, the boundary portion between the first groove 34 and the contact portion 42 is assigned as an insulating portion. Accordingly, for example, as compared with a configuration in which only the contact portion 42 is assigned as an insulating portion for the top portion 52A1 of the extension-line winding portion 52A, that is, a configuration in which the entire region between the tooth portion 20 and the top portion 52A1 of the extension-line winding portion 52A is formed of a resin portion, parasitic capacitance between the tooth portion 20 and the extension-line winding portion 52A can be reduced.

Next, a modified example of the present embodiment will be described.

In the above embodiment, the first gas layer 38 is formed between the tooth portion 20 and the winding wire winding portion 18, and the second gas layer 40 is formed between the core back portion 22 and the winding wire winding portion 18; however, either one of the first gas layer 38 and the second gas layer 40 may be omitted.

Further, in the above embodiment, the insulator 16 is constituted by a first insulator 58 and a second insulator 60 that are divided in the Z direction; however, the insulator 16 may be configured such that the first insulator 58 and the second insulator 60 are integrated with each other, that is, formed annularly around the tooth portion 20. In this case, the tooth portion 20 may be formed in a straight shape in the Y direction (that is, a shape having a constant cross section in the Y direction) such that the tooth portion 20 can be inserted into the inside of the insulator 16.

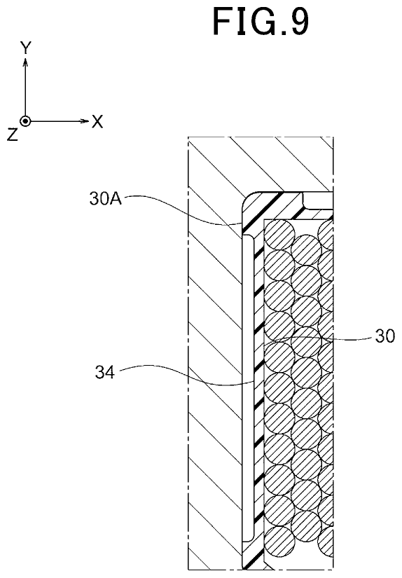

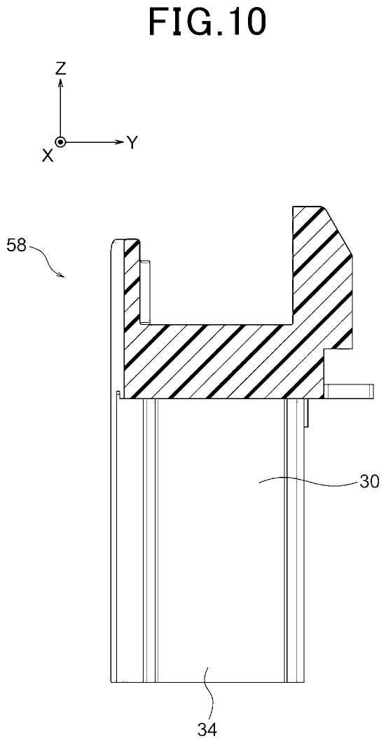

Further, in the above embodiment, the third contact portion 50 is formed at the central portion of the side wall portion 30, and the first grooves 34 are respectively formed on both sides of the third contact portion 50 on the opposing surface 30A of the side wall portion 30. However, as shown in FIGS. 9 and 10, the third contact portion 50 may be omitted from the central portion of the side wall portion 30, and a single first groove 34 may be formed on the opposing surface 30A of the side wall portion 30.

Further, in the above embodiment, the width of the third contact portion 50 along the Y direction is set to be equal to the width (diameter) of one winding portion 52 (see FIG. 4); however, as shown in FIG. 11, the width thereof may be set to be equal to the width of a plurality of winding portions 52. In the example shown in FIG. 11, the width of the third contact portion 50 along the Y direction is set to be equal to the width of two winding portions 52.

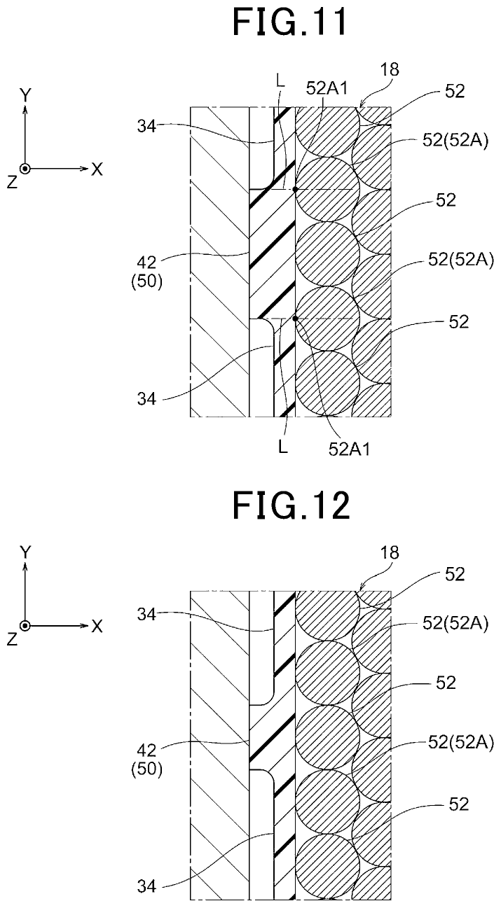

Further, in the above embodiment, the plurality of winding portions 52 are aligned such that the top portion 52A1 of the extension-line winding portion 52A on the side wall portion 30 side is located on the extension line L. However, as shown in FIG. 12, the plurality of winding portions 52 may be aligned such that none of the top portions thereof is located on the extension line L.

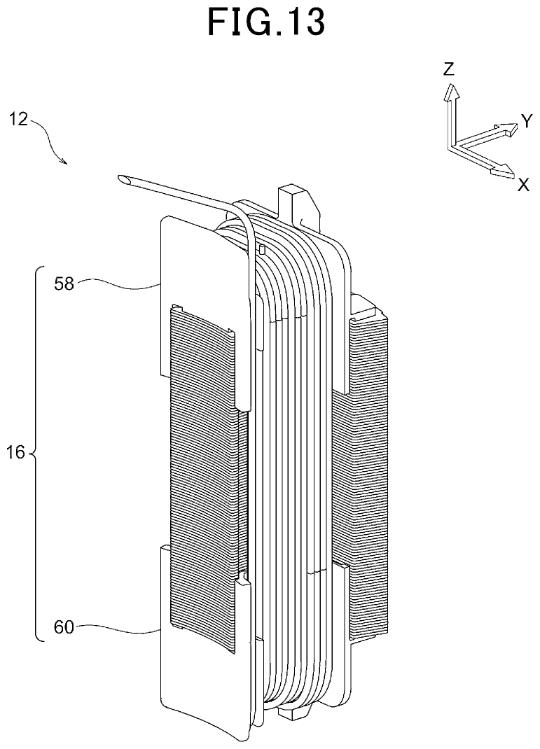

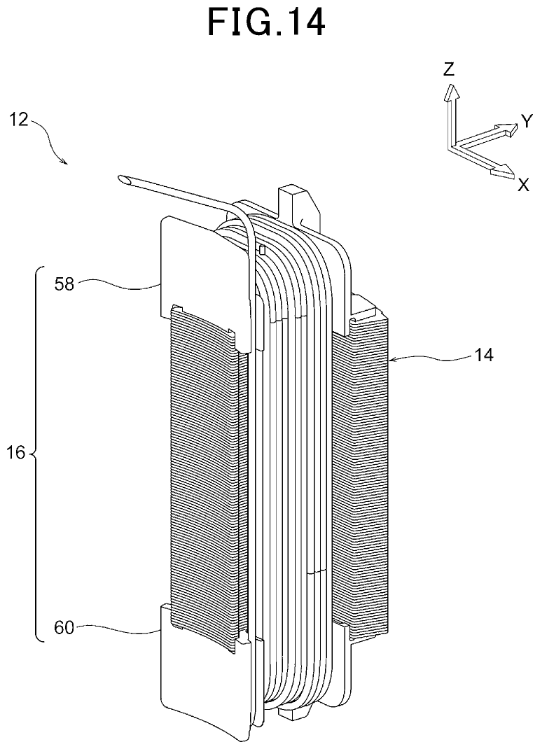

Further, in the above embodiment, the insulator 16 is constituted by the first insulator 58 and the second insulator 60 that are divided in the Z direction, and the first insulator 58 and the second insulator 60 are connected at the divided portion 62. However, as shown in FIG. 13, the first insulator 58 and the second insulator 60 may be spaced apart from each other in the Z direction. Further, as shown in FIG. 14, the first insulator 58 and the second insulator 60 may be configured to be attached to both end portions of the core member 14 in the Z direction.

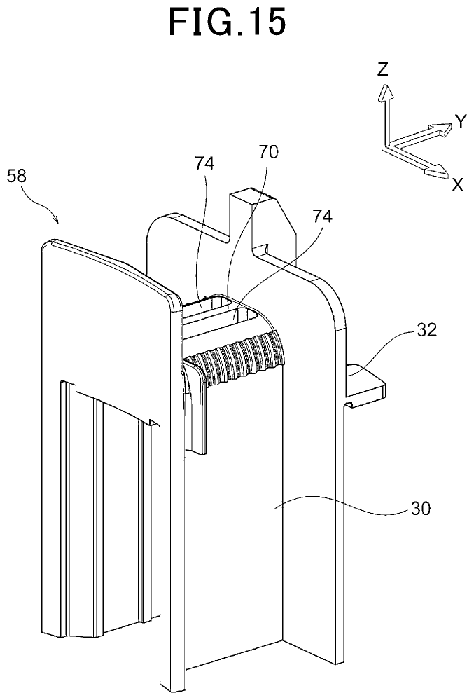

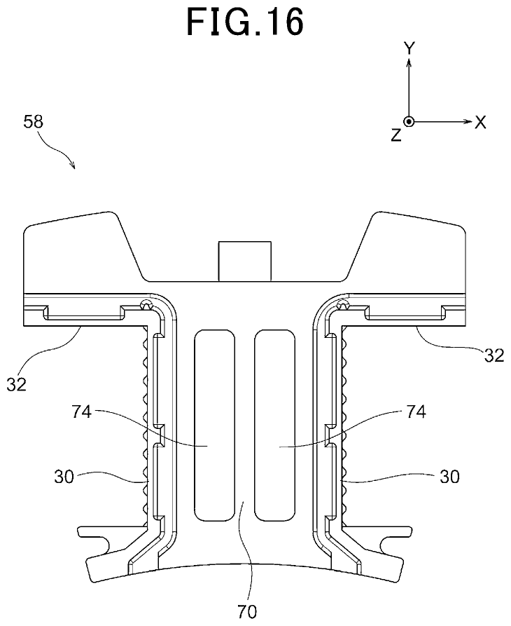

Further, in the above embodiment, the insulator 16 has the coil end insulating portion 70 disposed between the tooth portion 20 and the coil end portion 66. However, as shown in FIGS. 15 and 16, the coil end insulating portion 70 may have an opening portion 74 that is open in the Z direction. The opening portion 74 may penetrate in the Z direction, or may be formed in a recessed shape that is open only toward one side or the other side in the Z direction. The number of the opening portions 74 may be any number. With such a configuration, a gas layer is formed between the tooth portion 20 and the coil end portion 66 by the opening portion 74, whereby parasitic capacitance between the tooth portion 20 and the coil end portion 66 can be reduced.

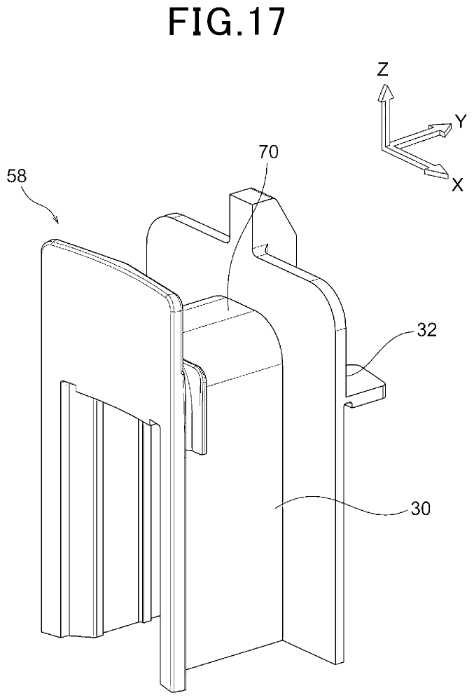

Further, in the above embodiment, the positioning portion 72 is formed at the connection portion between the coil end insulating portion 70 and the side wall portion 30. However, as shown in FIG. 17, the positioning portion 72 may be omitted from the connection portion (corner portion) between the coil end insulating portion 70 and the side wall portion 30.

Note that, among the plurality of modified examples described above, modified examples that can be combined may be combined with each other as appropriate.

While one embodiment of the present disclosure has been described above, the present disclosure is not limited to the above embodiment, and it goes without saying that various modifications may be made without departing from the gist of the present disclosure.

Hereinafter, supplementary notes relating to the present disclosure will be described.

### (Supplementary Note 1)

A stator (10) comprising:
a stator core (24) having a plurality of tooth portions (20) extending radially;
a resin insulator (16) attached to the stator core; and
a winding portion (18) wound around the plurality of tooth portions via the insulator,
wherein
   the insulator has attachment portions (30, 32) attached to attachment surfaces (20A, 22A) of the stator core,
   grooves (34, 36) opening toward the attachment surface side are formed in the attachment portions, and
   gas layers (38, 40) are formed between the stator core and the winding portion by the grooves.

### (Supplementary Note 2)

The stator according to Supplementary Note 1,
wherein
   the stator core has a core back portion (22) forming an outer peripheral portion of the stator core,
   the tooth portions extend radially inward from the core back portion of the stator core,
   the attachment surfaces include side surfaces (20A) of the tooth portions and an inner surface (22A) of the core back portion,
   the attachment portions include a first attachment portion (30) attached to the side surfaces of the tooth portions and a second attachment portion (32) attached to the inner surface of the core back portion,
   the grooves include a first groove (34) formed in the first attachment portion and opening toward the side surfaces of the tooth portions, and a second groove (36) formed in the second attachment portion and opening toward the inner surface side of the core back portion, and
   the gas layers include a first gas layer (38) formed between the tooth portions and the winding portion, and a second gas layer (40) formed between the core back portion and the winding portion.

### (Supplementary Note 3)

The stator according to Supplementary Note 2,
wherein
   the first attachment portion has contact portions (42) formed adjacent to the first groove and contacting the side surfaces of the tooth portions, and
   the contact portions include a first contact portion (46) formed at one end portion of the first attachment portion in an extending direction of the tooth portions, and a second contact portion (48) formed at the other end portion of the first attachment portion in the extending direction of the tooth portions.

### (Supplementary Note 4)

The stator according to Supplementary Note 3,
wherein
   the contact portions include a third contact portion (50) formed at a central portion of the first attachment portion in the extending direction of the tooth portions.

### (Supplementary Note 5)

The stator according to Supplementary Note 3 or 4,
wherein
   a plurality of winding portions (52) of a first turn positioned on the first attachment portion side among the winding portion are aligned in the extending direction of the tooth portions,
   the plurality of winding portions include an extension-line winding portion (52A) positioned on an extension line (L) obtained by extending a boundary line between the first groove and the contact portion in a normal direction of the side surfaces of the tooth portions, and
   a top portion (52A1) of the extension-line winding portion on the first attachment portion side is positioned on the extension line.

### (Supplementary Note 6)

The stator according to any one of Supplementary Notes 1 to 5,
wherein
   the winding portion has a coil end portion (66) wired on one axial side of the stator core relative to the tooth portions,
   the insulator has a coil end insulating portion (70) disposed between the tooth portions and the coil end portion, and
   the coil end insulating portion has an opening portion (74) opening in an axial direction of the stator core.

### (Conclusion)

As described, the present disclosure provides a stator capable of reducing parasitic capacitance.

According to one aspect of the present disclosure, a stator includes a stator core having a plurality of tooth portions extending radially, a resin insulator attached to the stator core, and winding portions wound around the plurality of tooth portions via the insulator. The insulator has attachment portions attached to attachment surfaces of the stator core. Grooves opening toward the attachment surface side are formed in the attachment portions. Gas layers are formed between the stator core and the winding portions by the grooves.

According to the present disclosure, there is provided a stator capable of reducing parasitic capacitance.

What is claimed is:

1. A stator comprising:
a stator core having a plurality of tooth portions extending radially;
a resin insulator attached to the stator core; and
winding portions wound around the plurality of tooth portions via the insulator, wherein
the insulator has attachment portions attached to side surfaces of the tooth portions;
grooves opening toward side surface side are formed in the attachment portions;
gas layers are formed between the tooth portions and the winding portions by the grooves;
the attachment portions each have contact portions formed adjacent to the corresponding groove and being in contact with the side surface of the corresponding tooth portion;
a plurality of winding portions of a first winding turn positioned on an attachment portion side among the winding portions are aligned in the extending direction of the tooth portions;
the plurality of winding portions include extension-line winding portions positioned on extension lines obtained by extending boundary lines between the grooves and the contact portions in a normal direction of the side surfaces; and
top portions of the extension-line winding portions on the attachment portion side are positioned on the extension lines.

2. The stator according to claim 1,
wherein
the stator core has a core back portion forming an outer peripheral portion of the stator core;
the tooth portions extend from the core back portion toward a radially inner side of the stator core;
the stator core includes side surfaces of the tooth portions and an inner surface of the core back portion;
the insulator includes, as the attachment portions, first attachment portions attached to the side surfaces of the tooth portions and second attachment portions attached to the inner surface of the core back portion;
in the first attachment portions, first grooves as the grooves are formed and opening toward the side surfaces of the tooth portions,
in the second attachment portions, second grooves are formed and opening toward the inner surface side of the core back portion; and
first gas layers as the gas layers are formed between the tooth portions and the winding portions by the first grooves and second gas layers are formed between the core back portion and the winding portions by the second grooves.

3. The stator according to claim 2,
wherein
the first attachment portions each have the contact portions formed adjacent to the corresponding first groove and being in contact with the side surface of the corresponding tooth portion; and
the contact portions include first contact portions formed at one end portion of the first attachment portions in an extending direction of the tooth portions, and second contact portions formed at the other end portion of the first attachment portions in the extending direction of the tooth portions.

4. The stator according to claim 3,
wherein
the contact portions include third contact portions formed at central portions of the first attachment portions in the extending direction of the tooth portions.

5. The stator according to claim 1,
wherein
the winding portions have coil end portions arranged on one axial side of the stator core with respect to the tooth portions;
the insulator has coil end insulating portions disposed between the tooth portions and the coil end portions, and
the coil end insulating portions have opening portions opening in an axial direction of the stator core.
